(19) United States
(12) Patent Application Publication
(10) Pub. No.: US 2017/0127656 A1
(43) Pub. Date: May 11, 2017

(54) Algae Farm

(71) Applicant: Cricor Inc., Saint Charles, MO (US)

(72) Inventors: Richard Bee, Saint Charles, MO (US); Christopher W. Gochanour, Dardenne Prarie, MO (US)

(21) Appl. No.: 15/350,086

(22) Filed: Nov. 13, 2016

Related U.S. Application Data
(60) Provisional application No. 62/253,851, filed on Nov. 11, 2015.

(51) Int. Cl. A01K 63/00; C02F 3/32; A01G 33/00; A01K 63/04; A01G 1/00

(52) U.S. Cl. CPC A01K 63/006; A01K 63/045; A01G 1/001; A01G 33/00; A01K 63/042; C02F 3/325; C02F 2103/20

(57) ABSTRACT

Apparatuses and methods for growing filamentous algae are disclosed. An apparatus comprises vertical surfaces such as plates or tubes which are suspended above the fill line of a water tank. Surfaces can have a frosted texture for algal growth. The surfaces are kept moist by pumping water from the tank through spray bars to the surfaces. Sprayed water drips back into the water tank. Algae growing on a surface can be processed into products such as biofuel and glycerin. Aquatic animals such as fish can be grown in a tank. An aquatic animal can generate nitrogenous waste as nutrient for algae, and provide food for human consumption. The amount of harvestable algae produced by an apparatus can exceed the amount produced from other systems of comparable size over comparable durations. An apparatus can also be utilized to scrub CO₂.

### CROSS REFERENCE TO PRIOR APPLICATION

This application claims benefit of and priority to U.S. Provisional Application 62/253,851, filed on Nov. 11, 2015. This application is hereby incorporated by reference in its entirety.

### INTRODUCTION

As the earth's supply of fossil fuels slowly dwindles, new, renewable sources of energy are urgently required. One potential class of fuels are plant-based fuels. The most common of these fuels are ethanol and biodiesel derived from corn and soy. While algae have long been investigated as a potential source of biofuels, most current methods do not produce enough oil at a practical scale. For example, a typical 650 L unicellular algae pond only yields about one ounce of oil.

U.S. Pat. No. 8,753,851 to Stephen et al. describes a system in which algae and bivalves are co-cultured in enclosures comprising water with recycled nutrients and separate enclosures for culturing fishes that harvest the algae by eating them. This system requires the use of planktivorous fish that eat unicellular algae, and algal biofuels are harvested from the fish. This system does not disclose the use of plates or the culturing of filamentous algae.

U.S. Pat. No. 8,685,707 to Poechinger discloses a system of growing filamentous algae in ponds with a conveyer system for harvesting. However, this system requires large amounts of water to allow the algae to flow from the ponds to the conveyor system, and does not disclose the use of plates or water pumps.

U.S. Pat. No. 8,689,482 to Cooke et al. discloses an apparatus and method for growing algae in “open” bodies of water such as lakes, rivers, oceans, streams and ponds. This invention excludes bioreactors and other artificial “closed” systems and only allows for mixed colonies of algae present in a natural water source; it does not teach inoculation of selected species. Furthermore, this patent teaches the use of vertically disposed fabrics and meshes as growth substrates, but does not teach or suggest the use of vertically disposed plates or tubes composed of a transparent or translucent material such as polycarbonate, acrylic or glass.

U.S. Pat. No. 8,800,202 to Rusiniak discloses a bioreactor comprising a plurality of horizontal trays with liquid on them and light sources above them. This patent does not disclose the use of recirculated water, vertical plates, or the use of filamentous algae.

US patent application publication 2007/0092962 by Sheppard et al. discloses a device for carbon dioxide sequestration. This apparatus includes substantially horizontal stacked trays that are lit by LEDs. However, this system discloses the use cyanobacteria, not filamentous algae and does not recite vertical plates or tubes. Furthermore, this technology purports to save energy by arranging the trays horizontally.

US patent application publication 2012/0149091 by Wilkerson et al. discloses a horizontal tray system with an effluent stream of nutrients and a lighting system. However, this published application does not disclose vertical plates or tubes, or the use of filamentous algae.

U.S. Pat. No. 8,713,850 to H. F. Seebo discloses an algae-growing structure comprising a plurality of horizontal growth plates that are covered in flowing, nutrient enriched water. This system does not disclose vertical plates or tubes, or the use of filamentous algae.

U.S. Pat. No. 4,236,349 to Ramus discloses a bioreactor comprising reaction chambers in which algae grow in a liquid culture. However, this patent does not disclose the growth of filamentous algae on vertical plates or tubes.

US Patent Application publication US2011/0078949 discloses an algal growth basin with vertical partitions and a pump to facilitate mixing of algae in liquid culture. However, the vertical partitions are contained within the water line, not suspended above it.

US Patent Application publication US2014/0199759 discloses a self-sustaining, self-contained system and method for producing biofuels and for producing biofuel feedstock from algae. However, this system does not include vertically disposed plates or tubes with frosted surfaces.

New methods and apparatuses are needed for producing biofuels.

### SUMMARY

The present inventors have developed, in various embodiments, systems, apparatuses and methods for growing filamentous algae, for growing aquatic animals such as fish, or for growing both filamentous algae and aquatic animals. In various configurations, a system or apparatus of the present teachings can grow algae at a faster rate compared to existing systems of similar size or scale, and yield greater amounts of algae compared to existing systems of similar size or scale. In various embodiments, algae produced by methods of the present teachings can be used, for example and without limitation, for production of glycerin, and/or production of a biofuel such triacylglycerol (TAG), which can be further processed into various useful materials such as a biodiesel fuel, a fertilizer, or a food additive. In various embodiments, a system or apparatus of the present teachings can be used to maintain and/or grow one or more aquatic animals such as fish, which can be used as a food source for humans, non-human animals, or both humans and animals. In various embodiments, a system or apparatus of the present teachings can be used to scrub carbon dioxide from a CO₂ source, such as an industrial source of CO₂.

In some embodiments, an apparatus of the present teachings can comprise a water tank which, when filled, can comprise an aqueous medium with a water fill line, i.e., a substantially horizontal surface of the aqueous medium that is exposed to ambient air. In various embodiments, an apparatus can further comprise one or more surfaces suspended above the water fill line of the water tank. In various configurations, a surface of the one or more surfaces suspended above the water line can be a substantially vertical surface. In various configurations, a substantially vertical surface can be, without limitation, a substantially vertical planar surface such as a flat plate or sheet positioned substantially vertically, a substantially vertical cylindrical surface such as tube positioned substantially vertically, or a combination thereof. In various embodiments, an apparatus can further comprise at least one water pump configured to pump an aqueous medium from the water tank to a substantially vertical surface. In various configurations, an apparatus can be configured to circulate the aqueous medium. In various configurations, a surface suspended above the water line can serve as a substrate which can support algal attachment, algal growth, or both. In some configurations, an apparatus can be configured for circulation of the aqueous medium. In some configurations, an apparatus can be configured for dripping or spraying the aqueous medium onto the one or more surfaces suspended above the water fill line. In some configurations, an apparatus can be configured for cyclically pumping aqueous medium from a tank to a substantially vertical surface, from where the medium can flow back to the tank.

In some configurations, a surface suspended above the water fill line can have at least one roughened or “frosted” portion. In some configurations, a surface suspended above the water fill line can comprise a material such as, but not limited to, a plastic such as polycarbonate or acrylic (Poly(methyl methacrylate) (PMMA) e.g., “PLEXIGLASS®” (Rohm and Haas Company, Philadelphia, Pa.), and/or glass. In various configurations, the material comprising a surface suspended above a water fill line can be a translucent or a transparent material. In various configurations, a surface suspended above a water fill line can be solid surface or a hollow surface. In various configurations, a surface suspended substantially vertically above a water fill line can be a hollow tube, a solid tube, a hollow plate, a solid plate, or a combination thereof. In some configurations, a plate can be a frosted polycarbonate plate. In some configurations, a plate can be a frosted acrylic plate. In some configurations, a plate can be a frosted glass plate. In some configurations, a surface can serve as substrate for algal attachment and/or growth.

In some configurations, an apparatus can include one or more screens, such as a fiberglass, wire or plastic screen. In various configurations, a screen can be attached to the substantially vertical surface. In some configurations, a screen can be a substrate for algal growth.

In some configurations, an apparatus can comprise a means for wetting the one or more surfaces suspended above the water fill line with the aqueous medium. In some configurations, a means for wetting the one or more surfaces suspended above the water fill line can include a means for moistening the one or more surfaces suspended above the water fill line with the aqueous medium. In various configurations, a means for moistening the surfaces can include a means for dripping the aqueous medium onto the one or more surfaces suspended above the water fill line, a means for spraying the aqueous medium onto the one or more surfaces suspended above the water fill line, or a combination thereof. In some configurations, a pump can be communicably coupled with the means for wetting the one or more surfaces suspended above the water fill line. In various configurations, a means for wetting the one or more surfaces suspended above the water fill line can include, without limitation, one or more nozzles, one or more spray tubes, one or more spray bars comprising one or more holes or nozzles, or a combination thereof. In some configurations, a spray bar can be configured to drip or to spray aqueous medium upon the one or more surfaces suspended above the water fill line.

In some configurations, a system or apparatus can further comprise a biofilter. In various configurations, a biofilter can comprise filtering material such as gravel, porous beads, porous rock such as lava rock, or a combination thereof. In some configurations, a biofilter can comprise nitrifying bacteria. In various configurations, a biofilter can comprise any combination of gravel, porous rock and nitrifying bacteria.

In some embodiments, a system or apparatus of the present teachings can comprise a single water tank. In some configurations, a single pump can circulate aqueous medium throughout the single-tank system or apparatus.

In some embodiments, a system or apparatus of the present teachings can comprise two or more water tanks, including at least one primary water tank and at least one second water tank. In various embodiments, an apparatus can further comprise one or more surfaces suspended above the water fill line of the at least one primary water tank. In various configurations, a surface of the one or more surfaces suspended above the water line of the at least one primary water tank can be a substantially vertically oriented surface. In various configurations, a surface suspended above the water line of the at least one primary water tank can be a hollow tube, a solid tube, a hollow plate, a solid plate, or a combination thereof.

In various configurations, a multi-tank system can comprise one, two or more pumps. In some configurations having at least one primary tank, at least one second tank, and two or more pumps, at least one first pump can be configured to pump aqueous medium to the one or more surfaces suspended above the water fill line of at least one primary tank. In some configurations having at least one primary tank, at least one second tank, and two or more pumps, at least one second pump can be configured to pump aqueous medium between the at least one primary tank and the at least one second tank.

In various configurations, a single-tank system or apparatus of the present teachings can comprise at least one aquatic organism or animal that produces nitrogenous waste. In some configurations, at least one tank can comprise a biofilter. In some configurations, a single-tank system or apparatus of the present teachings can further comprise at least one second pump which can be configured to pump aqueous medium through a biofilter.

In various configurations, a system or apparatus of the present teachings comprising two or more water tanks including at least one primary water tank and at least one second water tank, a second water tank can comprise at least one aquatic organism or animal which produces nitrogenous waste. In some configurations, at least one first pump can be configured to pump aqueous medium to the one or more surfaces suspended above the water fill line of the at least one primary tank. In some configurations having at least one primary tank, at least one second tank, and two or more pumps, at least one second pump can be configured to pump aqueous medium between the at least one primary tank and the at least one second tank. Furthermore, in some aspects, the at least one second pump can be configured to pump aqueous medium through a biofilter.

In some configurations, an apparatus of the present teachings can further comprise one or more lights configured to illuminate the one or more substantially vertical surfaces. In some configurations, a light source can be an LED or a fiber optic light. In some configurations, a light such as a fiber optic light can be configured to transmit light towards or through the one or more surfaces. In various configurations, the one or more lights can include one or more red lights, one or more blue lights, one or more white lights, or any combination thereof. In some configurations, the one or more lights can comprise an array of lights, such as, without limitation, a combination of red and blue LEDs. In some configurations, a light configured to illuminate a hollow surface can be a light source that emits light or provides light from within the hollow surface tube. In various configurations, the light can be an LEI). In various configurations, fiber optics in the vertical surface can illuminate the tube from a remote light source. In various configurations, the remote light source can be a growth light, LEDs, or the sun. In various configurations, a light source can be placed inside a hollow surface. In various configurations, a light source can be embedded in a vertical plate. In various configurations, a light source can be positioned within a hollow tube. In some configurations, a light source within a hollow tube can comprise fiber optic strands configured to illuminate the tube from a remote light source. In various configurations the light source can be an LED, a growth light, the sun or a combination thereof. In various configurations, the light source can provide light at wavelength ranges of approximately 400-450 nm, 450-500 nm, 400-500 nm, 600-650 nm, 650-700 nm, 600-700 nm, or a combination thereof.

In various configurations, a system or apparatus of the present teachings can further comprise algae or can be used to grow algae. In various configurations, the algae can be green algae. In some configurations, the algae can be filamentous algae. In some configurations, the algae can be Zygnematales algae. In some configurations, the algae can be Oedogonium algae. In some configurations, the algae can be Spirogyra algae. In some configurations, the apparatus can be inoculated with algae, such as algae selected from Zygnematales algae, Oedogonium algae, Spirogyra algae or a combination thereof.

In some configurations, an apparatus of the present teachings can further comprise a nitrogen source. A nitrogen source can include nitrogen in a reduced state, an oxidized state, or a combination thereof such as, without limitation, ammonia, ammonium, an amine, a nitrate, a nitrite, or a combination thereof. In some configurations, animal waste can serve as a nitrogen source.

In some configurations, an apparatus of the present teachings can comprise at least one aquatic organism that excretes nitrogenous waste, such as a saltwater or a freshwater animal, such as, without limitation, an invertebrate, for example a mollusk such as a bivalve mollusk such as a clam, an oyster, or a mussel; a crustacean such as a lobster, a crayfish or a crab; or a vertebrate, such as a fish or an amphibian such as a frog or a salamander, or a mammal such as a seal or sea lion. In some configurations, an animal can be a freshwater animal. In some configurations, an animal can be a saltwater animal. In some configurations, a fish can be a freshwater fish. In some configurations, a fish can be a saltwater fish. In various configurations, a fish can be, for example and without limitation, an African cichlid, arapaima, bass, barramundi, carp, catfish, cod, eel, koi, lungfish, perch, salmon, sturgeon, swai, tilapia or a trout. In various configurations, an aquatic organism can be, for example, a molly, a white albino catfish, a sword tail, a ghost shrimp, or a snail.

In some configurations, a system or apparatus of the present teachings can comprise a biofilter. In some configurations, a biofilter can comprise porous rock. In some configurations, the porous rock can be lava rock. In some configurations, a biofilter can comprise nitrifying bacteria, i.e., bacteria which can oxidize ammonia or ammonium to nitrate (NO₃—).

In some configurations, a water tank of the present teachings can be a fish tank. In some configurations, a water tank can comprise a material such as glass, acrylic, polycarbonate or a combination thereof.

In some embodiments, an apparatus of the present teachings can further comprise a conveyor belt. In various aspects, the conveyor belt can be configured to collect algae that fall from the one or more surfaces suspended above the water fill line, and deposit the algae into a receptacle. In various aspects, the conveyor belt can be a water permeable conveyer belt.

In some embodiments, an apparatus of the present teachings can further comprise a means for collecting algae. In some configurations, a means for collecting the algae can comprise a buoyant net. In some configurations, the means for collecting algae can comprise a water permeable conveyer belt.

In some configurations, an apparatus of the present teachings can further comprise a source of CO₂.

In some embodiments, a method of growing algae can comprise: a) providing an apparatus described herein; b) inoculating the apparatus with algae; c) filling the container with an aqueous medium; d) incubating the algae. In some configurations, the algae can be a filamentous algae. In some configurations, the algae can be Oedogonium. In some configurations, the algae can be Spirogyra. In some configurations, the one or more plates or tubes can be polycarbonate plates or tubes. In some configurations, the one or more plates or tubes can be acrylic plates or tubes. In some configurations, the one or more plates or tubes can have at least one frosted surface. In various configurations, a method of the present teachings can further comprise collecting algae that has grown in the apparatus. In various configurations, a method of the present teachings can further comprise collecting algae while it is growing in the apparatus. In some configurations, the collecting the grown algae can be automated. In some configurations, the apparatus can comprise a conveyor belt onto which the algae can drop upon falling off the one or more plates or tubes. In various configurations, the conveyor belt can transport the algae to a receptacle into which the algae are deposited.

In some configurations, a method of growing algae in accordance with the present teachings can further comprise including one or more living aquatic animals such as fish in the water tank. In some configurations, a method of growing algae in accordance with the present teachings can further comprise including one or more living aquatic animals such as fish in a second water tank in an apparatus comprising at least one primary water tank and at least one second water tank.

In some embodiments, the present teachings include methods of producing a biofuel. In some configurations, a method of producing biofuel can comprise: growing algae in accordance with a method of the present teachings, harvesting the algae, and processing the algae into a biofuel such as biodiesel. In some configurations, the algae can be filamentous algae. In some configurations, the algae can be Oedogonium. In some configurations, the algae can be Spirogyra. In some configurations, the biofuel can be biodiesel.

In some embodiments, the present teachings include methods of producing glycerin. In some configurations, a method of producing glycerin can comprise: growing algae in accordance with a method of the present teachings, harvesting the algae, and processing the algae into glycerin by methods well known to skilled artisans. In some configurations, the algae can be filamentous algae. In some configurations, the algae can be Oedogonium. In some configurations, the algae can be Spirogyra.

Embodiments of the present teachings include kits. In some configurations, a kit of the present teachings can comprise: a) a water tank: b) one or more plates or tubes, such as frosted plates or tubes; and c) a rack for suspending the one or more plates or tubes above a fill line of the water tank. In some configurations, a kit of the present teachings can further comprise algae, such as algae comprised by an algae culture. In some configurations, a kit of the present teachings can further comprise a coupon for an algae culture. In some configurations, a kit of the present teachings can further comprise a coupon for one or more fish.

In some embodiments, the present teachings include systems and apparatuses that can be used to scrub CO₂. In various configurations, a system for scrubbing CO₂ can comprise an apparatus of the present teachings, comprising at least one primary water tank and at least one second water tank, wherein the at least one primary water tank comprises algae, wherein one or more surfaces such as, without limitation, frosted plates or tubes are suspended above the at least one primary water tank. The at least one second water tank can comprise at least one aquatic animal such as a fish. A CO₂ source, such as, for example and without limitation, an industrial source of CO₂ as a waste product can be configured to supply CO₂ to the at least one primary water tank, for example by a pipe connection. In various configurations, as algae grow in the system, CO₂ can be absorbed by the growing algae. In some configurations, a system for scrubbing CO₂ can further comprise a means for collecting the algae. In some configurations, the means for collecting the algae can include a water permeable conveyer belt.

In some configurations, a system or apparatus for scrubbing CO₂ can further comprise a CO₂ sensor situated near the top of at least one primary water tank and can operate a valve that vents outside the system. In various configurations, the CO₂ sensor can be configured to close the valve if CO₂ is detected above a threshold concentration which can be selected by the user, such as, for example, and without limitation 450 ppm, 500 ppm, 550 ppm, 600 ppm, 700 ppm, 800 ppm, 900 ppm, or 1000 ppm, thereby limiting the concentration of CO₂. In some configurations, a system or apparatus for scrubbing CO can further comprise an O₂ sensor positioned near the fill line of at least one primary water tank. In some configurations, the O₂ sensor can be configured to open the valve if O₂ is detected above a threshold concentration which can be selected by the user, such as, for example, 5000 ppm, 0.1% volume, 18% volume or 19% volume, thereby increasing the intake of CO₂.

### BRIEF DESCRIPTIONS OF THE DRAWINGS

FIG. 1A-B illustrate a 30 gallon scale apparatus of the present teachings.

FIG. 1A illustrates a 30 gallon system of the present teachings.

FIG. 1B illustrates a partially exploded view of a 30 gallon system in which the lights and plates are shown separated from the tank.

FIG. 2A-G illustrate a 100 gallon scale multi-tank apparatus of the present teachings.

FIG. 2A illustrates a full view of a 100 gallon scale apparatus of the present teachings.

FIG. 2B illustrates a view of the primary tank of a 100 gallon scale apparatus with plates shown raised.

FIG. 2C illustrates water flow from the second tank of the 100 gallon scale apparatus to the primary tank of the 100 gallon apparatus.

FIG. 2D illustrates water flow through the primary tank of the 100 gallon apparatus.

FIG. 2E illustrates a partial view of the primary tank of the 100 gallon apparatus.

FIG. 2F illustrates a partial view of the second tank of the 100 gallon apparatus.

FIG. 2G illustrates water flow from the primary tank to the second tank of the 100 gallon apparatus.

### DETAILED DESCRIPTION

The present teachings include descriptions that are not intended to limit the scope of any aspect or claim. The examples and methods are provided to further illustrate the present teachings. Those of skill in the art, in light of the present disclosure, will appreciate that many changes can be made in the specific embodiments that are disclosed and still obtain a like or similar result without departing from the spirit and scope of the present teachings. As used herein, the singular forms “a”, “an” and “the” are intended to include the plural forms as well, unless the context indicates otherwise.

The present teachings include an apparatus and method for growing algae. In various configurations, algae production using a method and apparatus of the present teachings can produce, in less time and with fewer resources, more oil than traditional algal farming methods. For example, in traditional methods of growing unicellular algae, 650 liters of water in a pond can yield approximately one ounce of oil in 1-2 months (Demirbasa, A., Energy Conversion and Management, 52, 163-170, 2011). In contrast, for example, an apparatus of the present teachings comprising two 8×10 inch plates of algae grown in a 30 gallon tank can produce approximately the same amount of oil 1-2 months after initial system stabilization. An apparatus of the present teachings, equipped with two 8×10 inch plates and less than 30 gallons of water, can be used to produce as much oil in the same amount of time as a 650 L pond using traditional methods.

In various configurations, an apparatus of the present teachings can be scalable from small scale (for example, but without limitation, comprising a 30 gallon fish tank), or larger, e.g., for industrial applications.

In various embodiments, an apparatus of the present teachings can comprise one or more water tanks and one or more substantially vertical surfaces suspended within the one or more water tanks. Each substantially vertical surface can be a substantially flat surface, such as a plate, or a substantially round or cylindrical surface, such as a tube. In various configurations, a plate or tube can have at least one “frosted” or roughened surface. In various configurations, a plate or tube can be obtained commercially with a frosted surface; alternatively, a surface of a smooth plate or tube can be roughened with the aid of a file, sandpaper, or other scraping tool. In various configurations, a plate can be of any convenient length and width, such as, for example, a length of about 1 foot, about 2 feet, about 3 feet, about 4 feet, about 5 feet, about 6 feet, about 7 feet, about 8 feet, or longer, and a width of about 1 foot, about 2 feet, about 3 feet, about 4 feet, about 5 feet, about 6 feet, about 7 feet, about 8 feet, or longer. In various configurations, a plate can further comprise one or more sources of light embedded within, such as, without limitation, LED lights. In various configurations, a tube can be of any convenient length and diameter, such as a length of from about 1 foot, about 2 feet, about 3 feet, about 4 feet, about 5 feet, about 6 feet, about 7 feet, about 8 feet, about 9 feet, up to about 10 feet, or longer, and have a cross-sectional diameter in a range of from about ½ inch, about ¾ inch, about 1 inch, about 2 inches, about 3 inches, about 4 inches, about 5 inches, about 6 inches, about 7 inches, about 8 inches, about 9 inches, about 10 inches, about 11 inches, to about 12 inches, or wider. In various configurations, a tube can be hollow, and can further contain within it one or more light sources.

In use, a tank can comprise water or other aqueous medium up to a level beneath the substantially vertical plates or tubes (the “fill line” or “water line,” i.e., a surface of the aqueous medium that is exposed to ambient air). An apparatus can further comprise at least one water pump which can be configured to pump aqueous medium from the water tank to the frosted plates such that aqueous medium flows over the plates, thereby delivering aqueous medium comprising nutrients thereon. In some configurations, aqueous medium can be sprayed or dripped on to the plates or tubes. In some configurations, algae can grow on the plates or tubes, and can then slough off. In some embodiments, algae that are sloughed off can be collected by a conveyor belt situated beneath the plates or tubes, or other collection means. The conveyor belt can be configured to carry the algae to a receptacle configured to receive the algae. Furthermore, the conveyor belt can be a water-permeable conveyor belt.

In some configurations, a water tank can comprise one or more macroscopic aquatic animals such as fish. Without being limited by theory, it is believed that waste products from an aquatic animal can serve as nutrients in the aqueous medium which can be pumped to the algae. The waste products can thereby serve as nutrients which can promote algal growth. In some configurations, the animal excretions can be processed into bioavailable nutrients for the algae by a biofilter. In some configurations, a biofilter can comprise nitrifying bacteria, such as, for example, Nitrobacter or Nitrosomonas.

Some configurations of a system or apparatus of the present teachings can comprise a single water tank which can comprise both algae and an organism that excretes nitrogenous waste. In some configurations, a system or apparatus of the present teachings can comprise multiple water tanks. In multi-tank configurations, organisms such as fish can be maintained separately from a high CO₂ environment. In such configurations, one or more substantially vertical surfaces can be suspended above the water fill line of the water tank of a primary water tank and can serve as substrates for algal growth, while the nitrogen-excreting organism(s) can be housed in a second water tank. Aqueous medium can be pumped from a second water tank containing the aquatic organism(s) to a primary tank in which at least one substantially vertically oriented surface such as a plate or tube is suspended above the water line of a primary tank. The aqueous medium can drip or spray over the at least one plate or tube, and then can be collected by dripping into the primary water tank. Aqueous medium that has flowed over one or more algal growth surfaces can be pumped to the tank containing the organisms. In some configurations, aqueous medium can be pumped from the water tank containing aquatic animals through a biofilter.

### Components of the Apparatus

Water tank. In various embodiments, a water tank can be any container capable of holding water. Non-limiting examples include a fish tank, a bucket, a bottle, a bowl, a tub, an aquarium, a bin, a canister, a jar, a jug, a vase, a beaker, a vessel, a chest, a chamber, a vat, a stein, a pond, a pool, a basin, a cauldron, a cistern, a trough, or a receptacle. In various configurations, a water tank can be made out of a variety of water-tight materials, such as and without limitation, glass, plastic, acrylic, polycarbonate, or a combination thereof. In various embodiments, a water tank can hold a volume of water over a wide range of sizes, e.g., 20 gallons or larger, such as, without limitation, a 30 gallon tank, a 50 gallon tub, a 100 gallon tub, a 500 gallon aquarium, a 1000 gallon aquarium, a 5000 gallon tank, a 10,000 gallon tank, a 20,000 gallon tank, a 30,000 gallon tank, a 40,000 gallon tank, a 50,000 gallon tank, a 60,000 gallon tank, a 70,000 gallon tank, an 80,000 gallon tank, a 90,000 gallon tank, a 100,000 gallon tank, a 200,000 gallon tank, a 300,000 gallon tank, a 400,000 gallon tank, a 500,000 gallon tank, a 600,000 gallon tank, a 700,000 gallon tank, an 800,000 gallon tank, a 900,000 gallon tank, a 1,000,000 gallon tank, a 2,000,000 million gallon tank, a 3,000,000 gallon tank, a 4,000,000 million gallon tank, a 5,000,000 gallon tank, a 6,000,000 gallon tank, or a tank larger than 6,000,000 gallons. In some embodiments, a system can comprise multiple water tanks. In some embodiments, each tank of a group of one or more tanks can have one or more algal growth plates or tubes suspended it, while a separate group of one or more tanks can house one or more fish and/or other aquatic animals; the aqueous medium can be pumped throughout to circulate among the tank groups.

Vertical surfaces. As used herein, a vertical surface refers to a structure that provides a substrate upon which algae can grow. Such a surface can have multiple faces each of which can be moistened with aqueous medium containing a nitrogen source so that algae can grow. As used herein, a “face” is a side of a surface upon which algae can grow. A surface such as a plate can have multiple faces, or a surface such as a tube or cylinder can have one continuous face. Non-limiting examples of surfaces can include a plate, a block, a cone, a tube, a bottle, a cylinder, a box, a cup, and a bowl. Surfaces which can be used for various embodiments of the present teachings can comprise a variety of materials and sizes that can remain continuously in contact with water. These materials include, for example and without limitation, glass, plastic, acrylic, polycarbonate, and polypropylene. A surface can be of any color. In some configurations, a surface can have a translucent face which transmits light, or a transparent face which transmits light. In some configurations, a translucent face can enhance algal growth compared to an opaque face. In various configurations, a surface can comprise a smooth face or a frosted face. As used herein, a “frosted” surface such as a plate can include surface having a rough face, such as, for example, frosted glass or frosted acrylic. In various configurations, a plate having a rough face can be obtained from a supplier. In various configurations, a surface obtained from a commercial supplier with a smooth face can be roughened using sand paper, a file, sand-blasting or other mechanical means to create a roughened face texture, or chemical means such as treatment of glass with hydrofluoric acid and an alkali fluoride. Without being limited by theory, it is believed that a frosted texture can promote algal adhesion to a surface and thereby enhance algal growth.

Water pump. As used herein, a water pump can be any sort of pump capable of moving suitable amounts of water. Pumps that can be used in various configurations of the present teachings include centrifugal pumps and peristaltic pumps. In some configurations, a light duty pump such as an aquarium pump, e.g., a pump suitable for maintaining aquatic animals such as turtles or fish in aquaria can be used. In some configurations, a pump can be any pump capable of pumping water at a rate sufficient to maintain continuous flow over the surface area of the plates. In some configurations, a pump can be used to pump water from a plate-containing tank to a fish-containing tank at a rate that maintains both the flow of water over the plates and the level of water in the fish containing tank. In some configurations, an apparatus of the present teachings can comprise 1, 2, 3, 4, 5, 6, 7, 8, 9, 10, or more pumps configured to recirculate the water from a tank comprising aquatic animals to a tank comprising algae growth plates.

Lights. Many types of light sources that can help promote plant growth which can be utilized in an apparatus of the present teachings. In some configurations, a light can be a light that can enhance plant growth in general or algal growth in particular. For example and without limitation, sunlight can provide light sufficient to promote algal growth, and can be distributed using fiber optics. For example and without limitation, an artificial light source such as an LED or an array of LEDs can provide light sufficient to promote algal growth. In some configurations, an array of LEDs can comprise LEDs of one or more colors, such as, for example, a combination of red- and blue-emitting LEDs. Such LED lights can be obtained from a commercial supplier, such as, for example, Luma (Philips Corporation) LEDs. In some configurations, a fiber optic light source can be configured to transmit light through a plate or tube of the present teachings, thereby providing light to an algal growth surface. In various configurations, a fiber optic cable can be configured to transmit light to algae from a light source such as, without limitation, an LED, a metal-halide light such as a high intensity discharge (HID) iodine light, a compact florescent light (CFL), an incandescent light, the sun, or a combination thereof.

Aqueous medium. The aqueous medium can be any water-based medium suitable for supporting the algae and fish in a system of the present teachings. In various embodiments, an aqueous medium can be fresh water or salt water, depending upon the species of algae being grown. An aqueous medium can comprise salt or other additives appropriate for aquatic life, such as, without limitation, a water clarifying solution, a water conditioner, an enzyme preparation, a pH regulator and/or a dechlorinator. In some configurations, an aqueous medium can comprise, without limitation, tap water, spring water, or water from natural sources such as, without limitation, a lake, stream, river, pond, or the ocean. In some configurations, chlorinated water (such as chlorinated tap water) can be dechlorinated before being added to a system of the present teachings.

Algae. A system or apparatus of the present teachings can be used to grow many species of algae. Any form of filamentous multicellular algae or colony forming unicellular algae can be used in a system or apparatus of the present teachings. Non-limiting examples of filamentous algae include filamentous algae of the Linnean class Chlorophyceae and filamentous algae of the Linnean order Zvgnematales. In some embodiments, a system or apparatus of the present teachings can be used to grow algae of genera Oedogonium or Spirogyra.

In some configurations, a plate of an apparatus of the present teachings can be inoculated with an algae culture, for example by placing one or more strands of algae on a plate.

Nitrogen source. In some configurations, a system can include a nitrogen source, such as, without limitation, an organic nitrogen fertilizer such as, for example, MILORGANITE® (Milwaukee Metropolitan Sewerage District (MMSD), Milwaukee, Wis.). In some configurations, aquatic organisms such as fish, can serve as a nitrogen source.

Aquatic animals. In various configurations, a system of the present teachings can comprise aquatic animals such as fish. Without being limited by theory, it is believed that waste products from the fish can provide nutrients that can promote algal growth. In various configurations, fish comprised by a system of the present teachings can be maintained by standard aquarium or fish farming practices. Many different species of fish can be used in a system of the present teachings. In some configurations, fish species can be selected according to the size of the apparatus. Either saltwater fish or freshwater fish can be used, and can be selected and matched according to the algae being grown (e.g., freshwater algae can be grown in freshwater with freshwater fish; saltwater algae can be grown in saltwater with saltwater fish.) In various configurations, an apparatus or system can comprise any species of fish which can live in a tank comprised by the apparatus or system. In some configurations, an apparatus or system can comprise a fish species such as, for example and without limitation, a species that can be consumed by humans. Examples offish species that can be used in a system or apparatus of the present teachings include, without limitation: African cichlid, arapaima, bass, barramundi, carp, catfish, cod, eel, koi, lungfish, perch, salmon, sturgeon, swai, tilapia and trout. Trout species can include, without limitation: brook trout, brown trout lake trout, rainbow trout, ruby red trout, and steelhead.

Additionally, other aquatic animals can be used to provide nitrogenous waste that can promote algae development. These can include invertebrates such as, in non-limiting example, oysters, clams, and lobsters. An apparatus of the present teachings can also be coupled to aquatic habitats in aquariums or zoos to produce algal animal feed or biofuels. Animals kept in such enclosures can include, without limitation, invertebrates such as jellyfish, fish such as sharks and parrotfish, and aquatic mammals such as seals, sea lions, dolphins, and whales.

Biofilter. As used herein, a biofilter can used to convert waste products from a waste-producing organism into substances that can be metabolized by the algae. In some configurations, a biofilter can comprise nitrifying bacteria. In some configurations, nitrifying bacteria can be obtained from gravel, porous rocks or beads from an established aquarium or from a natural source such as pond water, lake water, stream water, or ocean water. In some configurations, gravel, porous beads or porous rocks such as and without limitation lava rock can be inoculated with nitrifying bacteria from a variety of sources. In various configurations, any form of nitrifying bacteria can be used, such as, for example and without limitation, nitrifying bacteria that are sold commercially for aquaria, such as, for example, ATM COLONY™ nitrifying bacteria (Acrylic Tank Manufacturing, Las Vegas, Nev.).

Algae collection. In some configurations, during operation of an apparatus of the present teachings, the algae while growing can spontaneously fall off of a substantially vertical surface such as a plate or tube. In some configurations, the algae can fall directly onto a water tank beneath. In some configurations, means for collecting algae can include, for example and without limitation, a net, a raft, a cloth, a mesh, a screen, a sieve, cheesecloth, or a perforated collection device. In some configurations, a net or other material such as a cloth or a mesh can be configured to float on the water's surface below the plates. In some configurations, aqueous medium flowing over the substantially vertical surfaces can pass through the material. While the aqueous medium is flowing, algae can fall off and float at the water's surface, ready to be collected.

In some configurations, algae can be collected using a water permeable conveyor belt, which can be positioned beneath the substantially vertical surfaces. A conveyor belt, can be configured to collect falling algae and carry the falling algae to a suitable receptacle. In some configurations, a water-permeable conveyer belt, such as a perforated conveyer belt, can be configured to transport algae dropping from the substantially vertical surfaces to a collection receptacle such as, without limitation, a storage drum, box, or a separate storage tank. In various configurations, a conveyer belt can be configured to transport the algae from beneath the vertical surfaces to a biofuel processing facility.

CO₂ source. In some configurations, atmospheric CO₂ can be sufficient for growing algae. In some configurations, an apparatus of the present teachings can be used to scrub CO₂ from a variety of sources such as CO₂ produced as an industrial waste product. Examples of sources of CO₂ include, without limitation: waste gases from industrial applications, flue gas, dairy farms, animal enclosures, internal combustion, coal gas, and waste gases from power plants.

Biofuel production. Methods of production of biofuels from algae, such as and without limitation, biodiesel, are well known in the art, and the algae produced from the apparatus described herein can be used to make biofuel in accordance with standard practices. Such suitable processes include, for example and without limitation, those described in Demirbasa. A., et al., Energy Conversion and Management, 52, 163-170, 2011 and Hossain, A. B. M. S., et al., American Journal of Biochemistry and Biotechnology, 4, 250-254, 2008, hereby incorporated by reference.

CO₂ and O₂ sensors. In various configurations, a sensor for CO₂ or O₂ can be any commercially available CO₂ or O₂ sensor, such as, for example, a sensor made by CO2Meter, Inc. (Ormond Beach, Fla.). A CO₂ or O₂ sensor can be configured to control valves that regulate the flow of gases in or out of the water tank containing the plates, and can be used to regulate CO₂ or O₂ using standard electronics such as, for example, an Arduino board and software configured to control inlet and outlet valves.

Spray bar. Any physical object capable of dispersing water over the plates can be used to distribute recirculated water. In various configurations, aqueous medium can be dispersed using a spray bar or fogger, for example a commercially available aquarium spray bar, a PVC pipe with holes to allow water escape, a sprinkler, water tubing with holes punched in it, a soaker hose or similar hose with holes that allow water to escape.

Power. A water pump in an apparatus of the present teachings can be powered through any number of conventional or non-conventional means. For example and without limitation, a power source can be conventional “wall current” AC electric outlet power, wind power, or solar power. Solar power can be obtained from a solar collector such as, for example, a solar panel on the roof of a building containing an apparatus of the present teachings.

### EXAMPLES

The present teachings including descriptions provided in the Examples that are not intended to limit the scope of any claim or aspect. Unless specifically presented in the past tense, an example can be a prophetic or an actual example. The following non-limiting examples are provided to further illustrate the present teachings. Those of skill in the art, in light of the present disclosure, will appreciate that many changes can be made in the specific embodiments that are disclosed and still obtain a like or similar result without departing from the spirit and scope of the present teachings.

The following reference numbers are used in the drawings:
1. Light
2. Water tank(s) (2a indicates a primary tank, 2b indicates a second tank)
3. Algae
4. Vertical plates
5. Net
6. Biofilter (rock)
7. Fish
8. Spray bar
9. Water pump
10. Outlet valve
11. Pipe connecting fish tank to plate tank
12. LEDs embedded in edges of plate
13. Irrigation heads
14. Suspension bars
15. Tubing
16. Gravel bed
17. Bucket containing biofilter
18. Pipe connecting plate tank to fish tank
19. Relief valve
20. Support frame

### Example 1

This example illustrates construction and use of a small scale system of the present teachings.

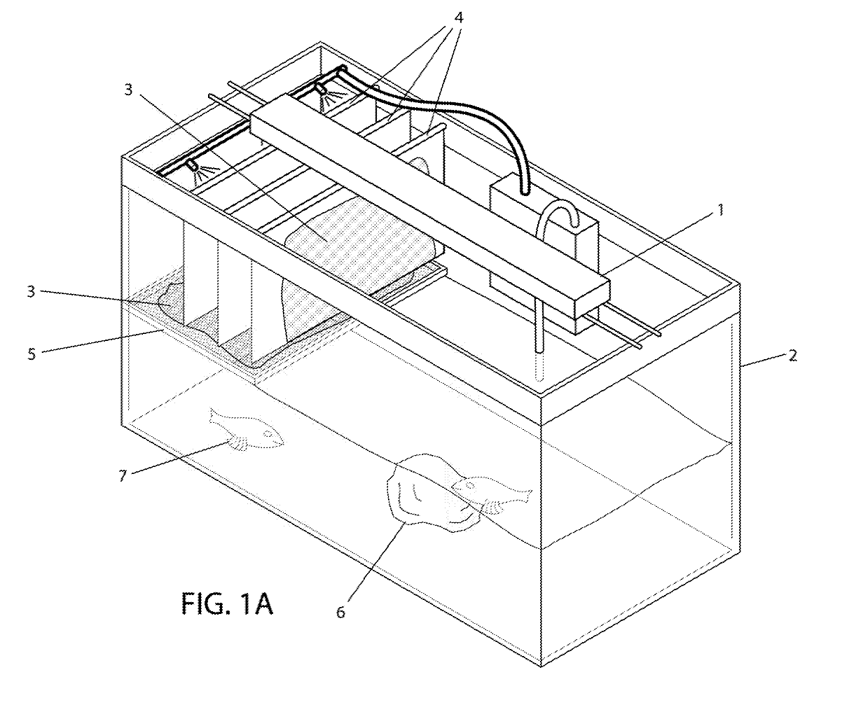

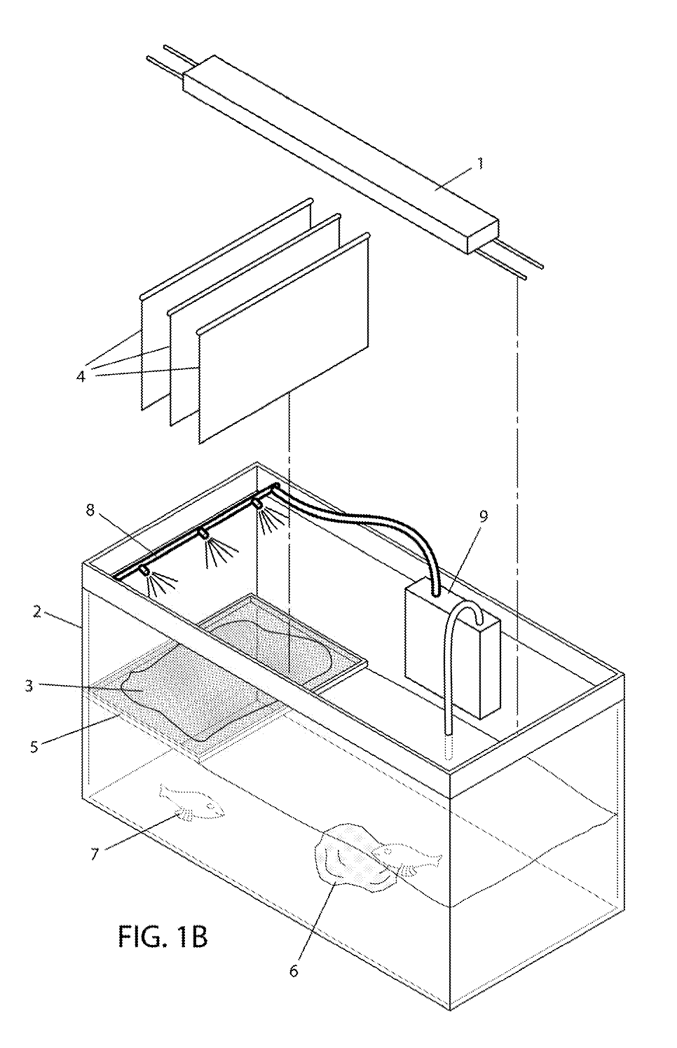

This system is depicted in use in FIG. 1A and FIG. 1B. The present inventor sanded three 8 inch by 10 inch acrylic plates (4) (FIG. 1B) and then suspended them from PVC pipes using curtain rings so that the plates extended approximately half way down into a 30 gallon fish tank (Grofizz, LLC, Austin, Tex.) (2) (FIG. 1A, FIG. 1B); the pipes rest on the rim of the fish tank. The fish tank was filled with reverse osmosis (RO) water to just below the surface of the plates. A turtle pump (9) (FIG. 1B) (Turtle Filter FX-350, EXO TERRA®, Mansfield, Mass.) was mounted on the back of the tank with a suction hose in the bottom of the tank and a spray hose above the algal plates to extract water from the bottom of the tank, through the filter, and into the spray bar (8) (FIG. 1A, FIG. 1B) made out of PVC pipes that had holes punched to form spray bars that continuously provided a flow of water down each of the three plates. Lava rocks inoculated with commercially purchased nitrifying bacteria (Tetra, Blacksburg, Va., and API, Chalfont, Pa.) (FIG. 1B) provided both loose in the tank (6) (FIG. 1A, FIG. 1B) in a container situation (not shown) on the bottom of the tank and growing live plants (not shown) served as a biofilter. An air stone situated at the bottom of the tank was used to aerate the water. A variety of small tropical fish (7) (FIG. 1A, FIG. 1B) including mollies, white albino catfish, two sword tails, eight ghost shrimp and two snails were added to the tank. Several of these animals bred, increasing the nitrogen output of the tank. A net (5) (FIG. 1A, FIG. 1B) comprising mesh stretched across buoyant tubes was placed under the plates to collect algae. A light comprising red and blue LEDs (1) (FIG. 1A, FIG. 1B) rested just above the plates at the top of the tank. A few strands of Odegonium and Spirogyra were placed on each plate to start the culture. Screens were affixed to one side of the plates (not shown). The fish were fed commercial fish food according to standard tropical fish care practices, and water was added to the tank when the water level fell below approximately 8 inches. The water temperature of the tank was maintained at approximately 75° F. throughout the duration of the experiment. When the system stabilized, the concentration factor (CF) was approximately 4. The initial growth on the plates took 4-6 weeks. After algae had been harvested, the plates' complete growth returned in 7-10 days. The inventors observed that algae fall off the plates upon growing to approximately inch thick. After 1.5 months, 50 grams (wet) algae (3) (FIG. 1A, FIG. 1B) had been produced and collected. The collected algae were processed by centrifuge drying and methyl alcohol separation to produce oil and glycerin.

### Example 2

This example describes the construction and use of a 100 gallon scale system.

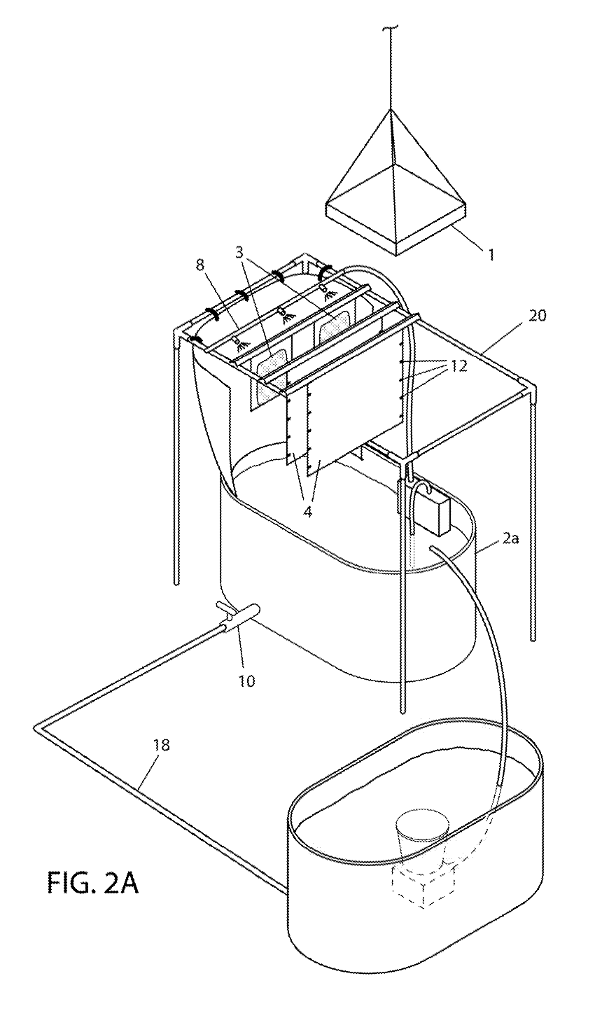

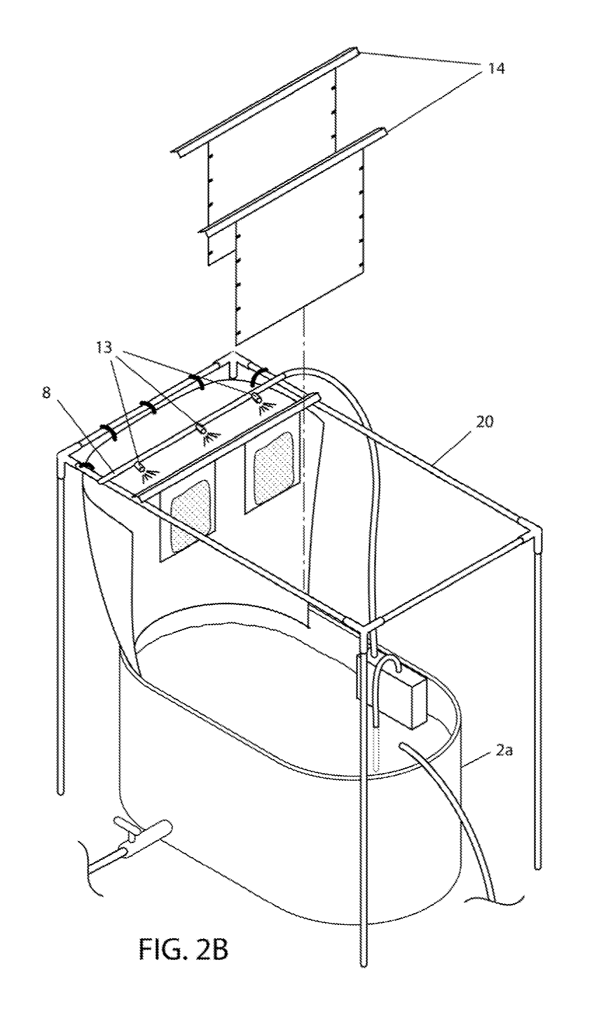

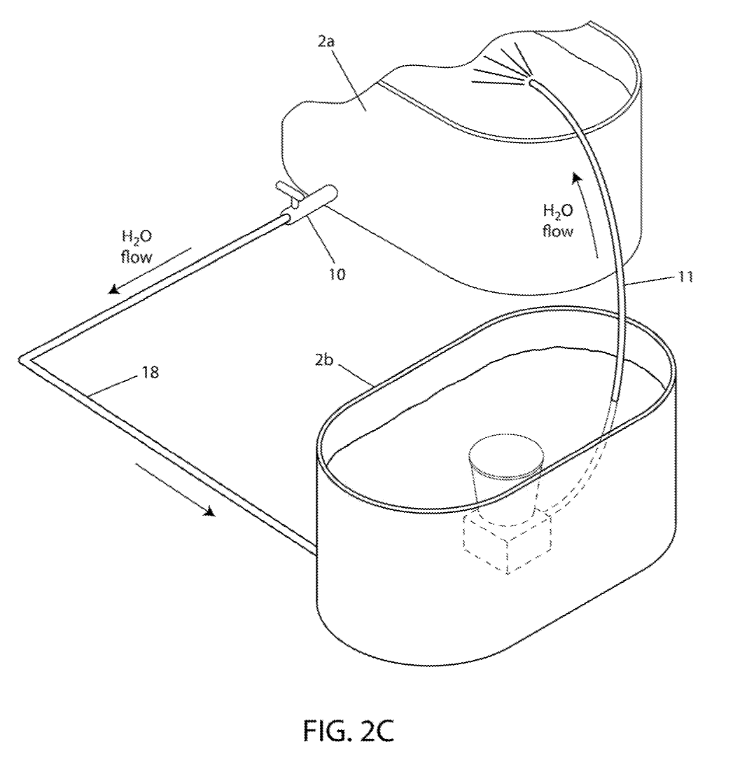

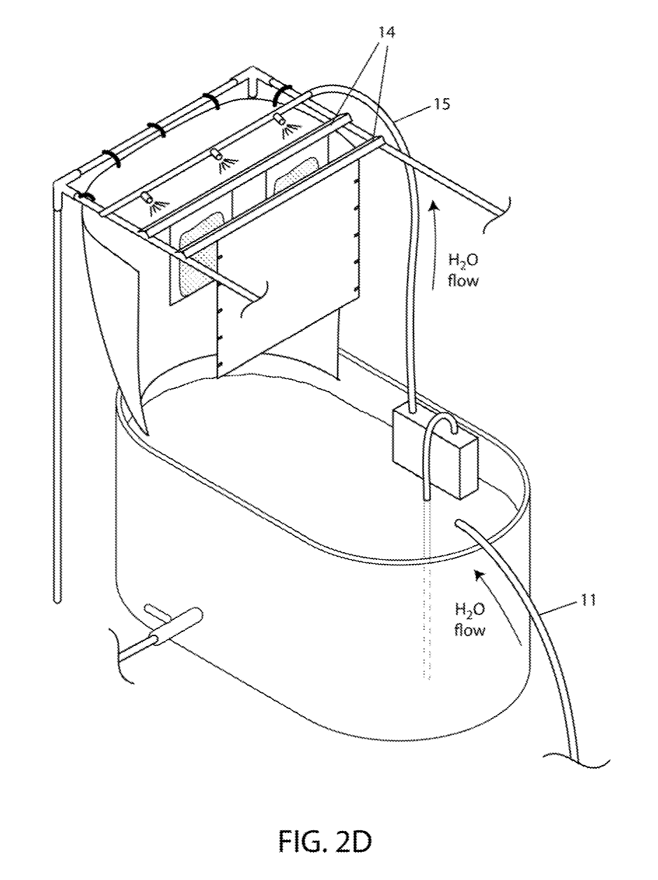

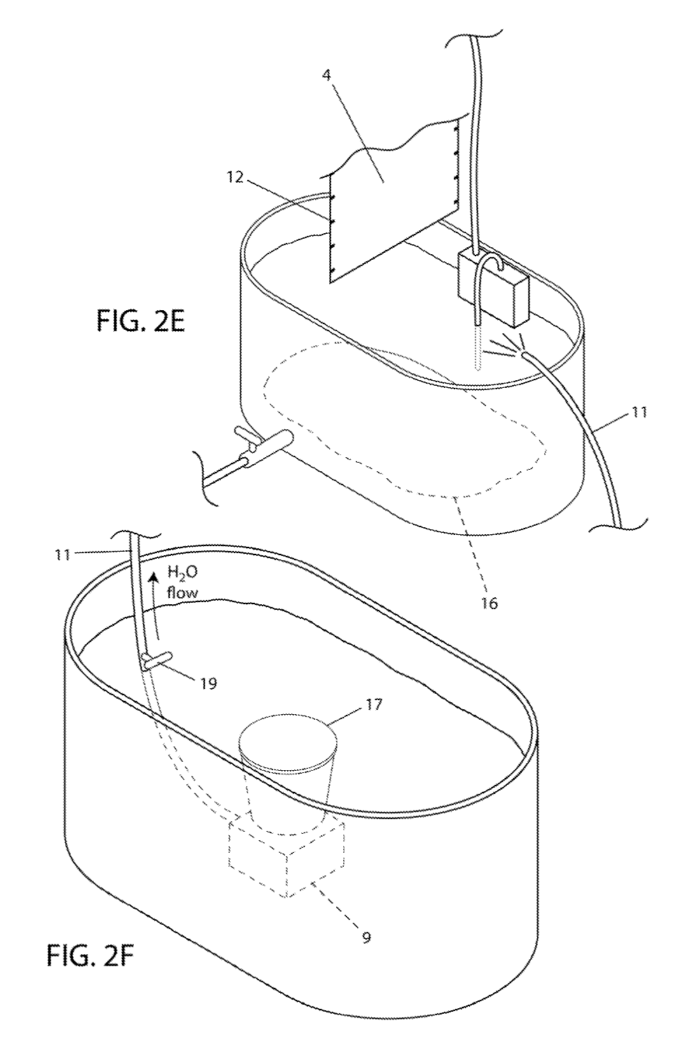

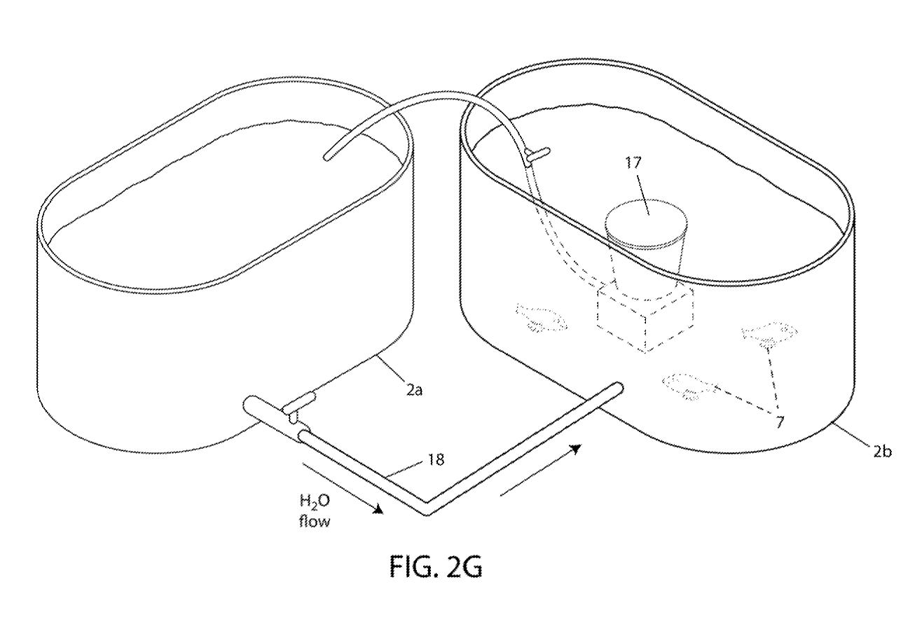

Drawings of this example are provided in FIG. 2A-2G. The present inventors constructed a frame using white PVC pipe arranged as a square at top with four legs extending from each corner of the square to the floor. Two 18 in×24 in acrylic plates were prepared by sanding the surfaces until rough and then fitting the edges with red and blue LEDs (12) (FIG. 2A, FIG. 2E). These prepared plates (4) (FIG. 1B, FIG. 2A) were then suspended from the frame into a first 100 gallon tank (2a) (FIG. 2A, FIG. 2B, FIG. 2C, FIG. 2F, FIG. 2G) (RUBBERMAID®) by V-shaped metal bars (14) (FIG. 2B, FIG. 2D) attached to the plates wherein the ends were allowed to rest on the PVC pipe frame (20) (FIG. 2A, FIG. 2B). The tank was filled with water such that the lower end of the plates rested just above the water's surface. A 650 gallons per hour (GPH) water pump submerged in the bottom of the primary tank was used to pump water from the bottom of the first 100 gallon tank through plastic tubing (15) (FIG. 2D) to a spray bar (8) (FIG. 2A, FIG. 2B) configured to spray water through irrigation heads (13) (FIG. 2B) onto the vertical plates (4) (FIG. 2A, FIG. 2E). A gravel bed (16) (FIG. 2E) was placed in the bottom of the tank. A second 100 gallon tank (2b) (FIG. 2C) was placed several feet away from the first 100 gallon tank. A 650 GPH water pump (9) (FIG. 2F) was submerged in the second tank. Water was pumped through a relief valve (19) (FIG. 2F) and then through PVC piping (11) (FIG. 2C, FIG. 21), FIG. 2E, FIG. 2F) suspended over the primary water tank (2a) (FIG. 2A, FIG. 2B, FIG. 2C, FIG. 2F), thereby transferring water from the second tank (2b) (FIG. 2C, FIG. 2G) to the primary tank. Water was pumped through an outlet valve (10) (FIG. 2A, FIG. 2C) through an additional pipe (18) (FIG. 2A, FIG. 2C, FIG. 2G) from the bottom of the primary water tank to the bottom of the second water tank. A five gallon bucket (17) (FIG. 2F, FIG. 2G) filled with clean lava rock and river pea gravel that had been inoculated with commercially available nitrifying bacteria from Tetra and API was submerged in the second tank (2b) (FIG. 2C, FIG. 2G), and water was pumped straight through into the primary tank (2a) (FIG. 2A, FIG. 2B, FIG. 2C, FIG. 2F). An aquarium air stone was added to oxygenate the water. One tilapia fish and six green koi were added to the second tank (7) (FIG. 2G). The previously seeded 8×10 inch growth plates from Example 1 were transferred to the large scale system and allowed to grow to saturation. The concentration factor of dissolved solids was monitored from 7.5 to 5.7 and stabilized to 4.5. When the concentration factor reaches 4.5 and the algal plates reach saturation, algae from these plates are then transferred to the larger plates as inoculum and allowed to grow.

### Example 3

This example describes a CO₂ scrubber of the present teachings.

A 12 foot by 20 foot by 100 foot first greenhouse or room is fitted with a steel frame and a 4 foot deep water tank, 4 foot by 8 foot frosted acrylic plates are suspended from the ceiling. The greenhouse is connected by a pipe to an industrial source of CO₂ such as a power plant flue. The pipe further includes a control valve. A CO₂ sensor is affixed to the top of the greenhouse wall approximately 1 foot from the ceiling. An O₂ sensor is affixed to the wall approximately 2 feet below the CO₂ sensor. The CO₂ sensor is configured to close the valve connected to the CO₂ source if the CO₂ sensor detects CO₂ concentration at or above a threshold level. The O₂ sensor is configured to open the valve connected the CO₂ source if the O₂ sensor detects O₂ concentration reaching a threshold level. These two sensors are configured such that as the room fills with CO₂, the valve closes, thereby limiting CO₂ concentration in the greenhouse; as the algae fix the CO₂ and excrete O₂, the valve opens thereby introducing more CO₂ into the room. This arrangement can be used to maintain CO₂ concentration in an optimal range for promoting algal growth for the species of algae grown.

The plates are seeded with filamentous algae. Spray bars suspended from the ceiling spray aqueous medium continuously onto the plates. Medium drips from the plates into the four foot water tank in the floor of the greenhouse. Medium is pumped into an adjoining second greenhouse or room which houses a 1,000 gallon fish tank. The fish tank contains tilapia. Aqueous medium from the fish tank is pumped through a biofilter comprising lava rocks and nitrifying bacteria, and then into the spray bar in the first greenhouse containing the plates. The algae grown are collected, and can be processed into biofuel. The tilapia grown is suitable for human consumption.

### Example 4

This example describes a CO₂ scrubber of the present teachings.

A 12 foot by 20 foot by 100 foot first greenhouse or room is fitted with a steel frame and a 4 foot deep water tank, 8 foot long polycarbonate tubes of 2 inch cross-sectional diameter are suspended from the ceiling. The tubes encase LED lights, and also contain fiber optic strands configured to transmit sunlight through the tubes. The greenhouse is connected by a pipe to an industrial source of CO₂ such as a power plant flue. The pipe further includes a control valve. A CO₂ sensor is affixed to the top of the greenhouse wall approximately 1 foot from the ceiling. An O₂ sensor is affixed to the wall approximately 2 feet below the CO₂ sensor. The CO₂ sensor is configured to close the valve connected to the CO₂ source if the CO₂ sensor detects CO₂ concentration reaching a threshold level. The O₂ sensor is configured to open the valve connected the CO₂ source if the O₂ sensor detects O₂ concentration reaching a threshold level. These two sensors are configured such that as the greenhouse fills with CO₂, the valve closes, thereby limiting CO₂ concentration in the room; as the algae fix the CO₂ and excrete O₂, the valve opens thereby introducing more CO₂ into the room. This arrangement can be used to maintain CO₂ concentration in an optimal range for promoting algal growth for the species of algae grown.

The tubes are seeded with filamentous algae. Spray bars suspended from the ceiling spray aqueous medium continuously onto the tubes. The medium drips from the tubes into the four foot water tank in the floor of the greenhouse. Medium is pumped from the four foot water tank into an adjoining second greenhouse or room which houses a 1,000 gallon fish tank. The fish tank contains tilapia. Aqueous medium from the fish tank is pumped through a biofilter comprising lava rocks and nitrifying bacteria, and then to the spray bar in the primary greenhouse containing the plates. The algae grown is collected, and can be processed for biofuel. The tilapia grown is suitable for human consumption.

### Example 5

This example illustrates an example of a 100 gallon scale system.

A frame of white PVC pipe arranged as a square at top with four legs extending from each corner of the square to the floor is constructed. Two 24 inch plastic tubes 2 inches in diameter are suspended from the frame into a primary 100 gallon tank. The tank is filled with water such that the lower end of the tubes rests just above the water's surface. A 650 gallons per hour (GPH) water pump on the bottom of the primary tank pumps water from the bottom of the primary 100 gallon tank through plastic tubing to a spray bar configured to spray water through irrigation heads onto the plastic tubes. Fiber optic cabling is strung through the tubes for illumination. The fiber optic cables lead to a window where they can gather sunlight. A gravel bed rests on the bottom of the tank. A second 100 gallon tank is placed several feet away from the primary 100 gallon tank. A 650 GPH water pump is submerged in the second tank. Water is pumped through a relief valve and then through PVC piping suspended over the primary water tank, thereby transferring water from the second tank to the primary tank. Water is pumped through an additional pipe from the bottom of the primary water tank to the bottom of the second water tank. Lava rock and river pea gravel are inoculated with commercially available nitrifying bacteria from Tetra and API is contained in a 5 gallon bucket in the second tank, and water is pumped straight through into the primary tank. An aquarium air stone oxygenates the water. One catfish and seven trout are added to the second tank, where they grow until removed for consumption.

All cited references are incorporated by reference, each in its entirety. Applicant reserves the right to challenge any conclusions presented by the authors of any reference.

What is claimed is:

1. An apparatus comprising:
a) a primary water tank comprising a water fill line;
b) one or more substantially vertical surfaces; and
c) a water pump configured to pump water from the primary water tank to the one or more substantially vertical surfaces, wherein each surface of the one or more substantially vertical surfaces is suspended above the water line.

2. The apparatus of claim 1, wherein at least one surface of the one or more substantially vertical surfaces is a substantially vertical tube.

3. The apparatus of claim 2, wherein the substantially vertical tube is a hollow substantially vertical tube.

4. The apparatus of claim 1, wherein at least one surface of the one or more substantially vertical surfaces is a substantially vertical plate.

5. The apparatus of claim 1, wherein at least one surface of the one or more substantially vertical surfaces is a frosted substantially vertical surface.

6. The apparatus of claim 1, further comprising one or more lights configured to illuminate the one or more substantially vertical surfaces.

7. The apparatus of claim 1, further comprising an aqueous medium.

8. The apparatus of claim 1, further comprising algae.

9. The apparatus of claim 8, wherein the algae are filamentous algae.

10. The apparatus of claim 8, wherein the algae are selected from the group consisting of Zygnematales algae, Oedogonium algae, Spirogyra algae and a combination thereof.

11. The apparatus of claim 1, further comprising a nitrogen source.

12. The apparatus of claim 7, further comprising one or more aquatic animals.

13. The apparatus of claim 7, further comprising one or more fish.

14. The apparatus of claim 7, further comprising a biofilter.

15. The apparatus of claim 14, wherein the biofilter comprises nitrifying bacteria and filtering material selected from the group consisting of gravel, porous beads, porous rock and a combination thereof.

16. The apparatus of claim 8, further comprising a conveyor belt situated beneath the one or more substantially vertical surfaces.

17. The apparatus of claim 16, wherein the conveyor belt is a water-permeable conveyor belt.

18. The apparatus of claim 1, further comprising d) a second water tank, wherein the primary water tank comprises algae, and the second water tank comprises one or more aquatic animals.

19. The apparatus of claim 18, further comprising:
e) a first room comprising the primary water tank;
f) a second room comprising the second water tank; and
g) at least one CO₂ source communicably connected to the primary water tank.

20. The apparatus of claim 19, further comprising:
h) a CO₂ sensor within the first room near the top of the primary water tank; and
i) a valve operably connected to the CO₂ source, wherein the CO₂ sensor is configured to close the valve if CO₂ is detected above a threshold level.

21. The apparatus of claim 20, further comprising:
j) an O₂ sensor positioned below the CO₂ sensor, wherein the O₂ sensor is configured to open the valve if O₂ is detected above a threshold level.

22. A method of growing algae, comprising:
a) providing the apparatus of claim 8; and
b) incubating the algae.

23. The method of claim 22, wherein the apparatus further comprises one or more aquatic animals.
